(19) United States
(12) Patent Application Publication
(10) Pub. No.: US 2017/0113807 A1
(43) Pub. Date: Apr. 27, 2017

(54) FUEL SYSTEM

(71) Applicant: Airbus Operations Limited, Bristol (GB)

(72) Inventors: Stephen BURNELL, Bristol (GB); Tim Leigh, Bristol (GB)

(21) Appl. No.: 15/335,172

(22) Filed: Oct. 26, 2016

(30) Foreign Application Priority Data
Oct. 26, 2015 (GB) 1518880.8

(51) Int. Cl. B64D 37/32; B01D 53/00; B64D 37/10

(52) U.S. Cl. CPC B64D 37/32; B64D 37/10; B01D 53/00

(57) ABSTRACT

A method and apparatus of control of fuel in a fuel tank including use of pneumatics employing a non-reactive gas. The aircraft fuel tank is handled and monitored by a pneumatic apparatus using oxygen depleted air from air separation module or auxiliary power unit of the aircraft. Electrical discharge from electrical apparatus is obviated.

### RELATED APPLICATION

This application claims priority to Great Britain patent application 1518880.8, filed Oct. 26, 2015, the entirety of which is incorporated by reference.

### TECHNICAL FIELD

This invention relates to a fuel system and related methods.

### BACKGROUND TO THE INVENTION

Liquid fuel for vehicles is generally contained within a rigid tank having a filling aperture and an outlet to a fuel consumer, such as an engine. The volume of liquid fuel in the tank varies between refills, and the space above the liquid fuel (ullage) is a vapour, which should not be exposed to an ignition source.

In the case of an aircraft in flight, regulations require that no ignition source be present in the fuel tank. The generally accepted value of electrical energy necessary to ignite fuel vapours is about 0.2 Mj.

Electrical systems are however used to control and monitor fuel in an aircraft fuel tank. Such systems are convenient, and the use of electrical apparatus in such systems is ubiquitous. Electrical apparatus may include, for example, fuel pumps, level monitoring apparatus, flow control valves, pressure switches and the like. Care is taken to avoid any risk of an energy discharge. Electrical systems within aircraft fuel tanks are considered to be safe.

In order to further mitigate the potential for ignition of fuel vapour, it is known in aircraft to fill the space above liquid fuel with a gas which will not support combustion. One common technique is to use oxygen depleted air (ODA) in the void above the liquid fuel; ODA has an oxygen content reduced to about 11-12% by volume. ODA is typically produced in an air separation module of an aircraft, and is maintained in the fuel tank at slightly above the air pressure on the exterior of the fuel tank. The use of an in-tank gas which will not support combustion is commonly known as ‘inerting’, and may be used in any liquid fuel tank where the risk of ignition must be mitigated.

As noted above, electrical devices continue to be used in tanks for liquid fuel. It would be desirable to eliminate electrical devices, or at least to locate them outside the fuel tank.

A pneumatic drive fuel pump is disclosed in U.S. Pat. No. 2,307,566.

### SUMMARY OF THE INVENTION

A first aspect of the invention provides a method of operating a fuel system, the fuel system comprising a fuel tank, a device located at least partially inside the fuel tank, a pneumatic/electrical interface outside the fuel tank, and a pneumatic signal line between the device and the pneumatic/electrical interface, the method comprising: conveying information from the device to the pneumatic/electrical interface by means of a pneumatic signal carried by a gas in the pneumatic signal line; and operating the pneumatic/electrical interface to convert the pneumatic signal into an electrical signal.

The first aspect of the invention also provides a fuel system comprising a fuel tank, a device positioned at least partially inside the fuel tank, a pneumatic/electrical interface outside the fuel tank, and a pneumatic signal line between the device and the pneumatic/electrical interface, wherein the pneumatic signal line is arranged to convey information from the device to the pneumatic/electrical interface by means of a pneumatic signal carried by a gas in the pneumatic signal line, and the pneumatic/electrical interface is arranged to convert the pneumatic signal into an electrical signal.

The device is typically a device associated with liquid fuel and for controlling measuring, signalling, monitoring, pumping, draining or filling. The pneumatic/electrical interface is typically an electrical or electronic device associated with control of liquid fuel within the tank, and may be for example a microprocessor or fuel computer.

The pneumatic signal line conveys non-electrical signals from the fuel tank, thus obviating any risk of in-tank electrical discharge. The pneumatic signal line may be a pipe, and the information may be conveyed by, for example, varying the pressure of gas in the pipe.

A further advantage of using pneumatics as an interface between the device and the pneumatic/electrical interface is the relative ease of making a sealed connection through the fuel tank wall, for example by using conventional bulkhead fittings, as compared with making a corresponding electrical connection. Leakage of gas from the pneumatic signal line is not unacceptable.

Typically the device is a sensor, such as a pressure switch, a float valve, or an open downwardly facing tube which becomes immersed when the level of fuel in the fuel tank increases above a desired height. Typically the information conveyed by the pneumatic signal line is a fuel parameter such as fuel pressure, fuel flow rate or fuel height.

The gas in the pneumatic signal line may be air, or a non-reactive gas (that is, a gas which having regard to the fuel of the tank will not react adversely with the fuel, and in particular will not support combustion). Optionally the non-reactive gas may be exhausted into the fuel tank.

A second aspect of the invention provides a method of controlling a flow of fuel in a fuel system, the method comprising: supplying non-reactive gas to a pneumatic device; operating the pneumatic device to control a flow of fuel in the fuel system; and using the non-reactive gas to control the operation of the pneumatic device.

The second aspect of the invention also provides a fuel system comprising: a pneumatic device; and a gas supply line for supplying non-reactive gas to the pneumatic device, wherein the pneumatic device is arranged to control a flow of fuel in the fuel system, and wherein the gas supply line is arranged to control the pneumatic device by means of the non-reactive gas in the gas supply line.

The method of the second aspect of the invention, in one embodiment, may comprise pressurizing the non-reactive gas for use in a pneumatic motor or the like. Such a pneumatic motor may be a linear or rotary actuator having a reciprocating action, or a rotary motor. The non-reactive gas may be conditioned, for example by filtering, cooling, pressurizing, and/or drying, and such conditioning may vary according to input quality, for example fuel cell exhaust air may require to be dried to a greater extent than cabin exhaust air.

Optionally the fuel system comprises a fuel tank and the method further comprises exhausting the non-reactive gas from the pneumatic device into the fuel tank.

The non-reactive gas may be used to remove moisture from fuel, so called fuel dehydration; in one example exhaust non-reactive gas from a submerged pneumatic fuel pump may be allowed to bubble through liquid fuel so as to remove moisture therefrom.

In one embodiment of the invention, the non-reactive gas is identical in composition to a non-reactive gas used for inerting an aircraft fuel tank. Such non-reactive gas may be obtained from a conventional air separation module (ASM) or auxiliary power unit of an aircraft.

Typically the non-reactive gas is a gas which will not react adversely with the fuel, and in particular will not support combustion. The non-reactive gas may be inert and may be a single gas or a combination of gases.

Typically the non-reactive gas has either no oxygen, or an oxygen concentration below 15% or 13% by volume. For instance the non-reactive gas may be pure nitrogen, or oxygen-depleted air with an oxygen concentration below 15% by volume or below 13% by volume. Optionally the oxygen-depleted air is generated by removing oxygen from air at an air separation module.

In one embodiment of the first or second aspect of the invention, the non-reactive gas is oxygen-depleted air (ODA), and the fuel is kerosene. In this example, any leakage of ODA will neither cause deterioration of the fuel, nor contaminate or dilute ODA which is forming a non-combustible blanket over the liquid fuel. This embodiment is particularly appropriate to fuel tanks of aircraft.

Typically the fuel system of the second aspect of the invention comprises a fuel tank. The pneumatic device may be located entirely outside the fuel tank, but may be located at least partially inside the fuel tank, or fully inside the fuel tank so that the gas supply line is immersed in fuel.

Optionally the pneumatic device is a pump, a pressure regulator, a motor, a valve, a switch, or an actuator. In the case of a pump, the pneumatic device controls the flow of fuel in the fuel system by pumping the fuel, and the gas is typically used to energise the pump and act as a pneumatic power source causing the pump to pump the fuel. In the case of a pressure regulator, the pneumatic device controls the flow of fuel in the fuel system by regulating a pressure of the flow of fuel, and the pressure of the gas is typically used to adjust a setting of the pressure regulator to adjust the pressure of the flow of fuel.

The fuel system of the first or second aspect of the invention may be an aircraft fuel system. The first and second aspects of the invention enable electrical apparatus to be replaced, thus removing a potential source of ignition. The invention provides considerable additional safety advantages when applied to an aircraft.

Pneumatic motors and actuators may have the further potential of being substantially smaller and lighter than an equivalent electric device, so that weight and cost of aircraft components in particular may be reduced. Furthermore some pneumatic components may be installed in-tank, whereas the equivalent electrical apparatus may be outside the fuel tank. In such cases it may be easier to seal a pneumatic conduit in the tank wall than an electrical conduit.

Typically the pneumatic signal line or gas supply line may be constituted by rigid or flexible pipes, or a combination thereof, having an internal bore appropriate to the flow and pressure specification. Typically a gas supply line associated with a pneumatic motor may be large to accommodate the necessary volumetric flow, whereas a pneumatic signal line associated with a measuring function, such as fuel pressure, may be relatively small since flow is not required.

### BRIEF DESCRIPTION OF DRAWINGS

Other features of the invention will be apparent from the following description of embodiments of the invention, illustrated by way of example only in the accompanying schematic drawings in which:

FIG. 1 is a schematic illustration of an exemplary fuel system of an aircraft;

FIGS. 2 and 3 illustrate by reference to pneumatic circuit symbols, a float valve for use in the invention;

FIG. 4 illustrates an alternative magnetic float switch; and

FIG. 5 illustrates a pneumatic level detector.

### DESCRIPTION OF AN EMBODIMENT OF THE INVENTION

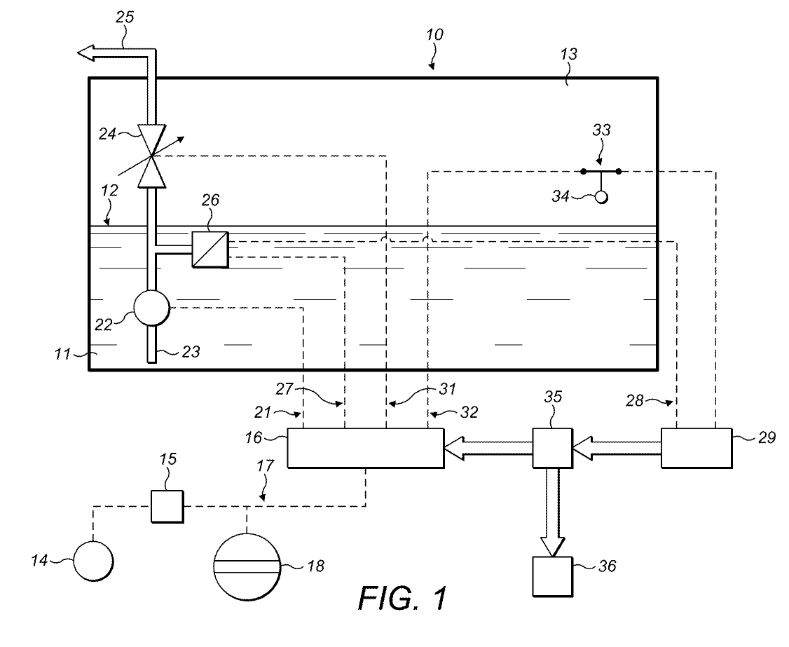

FIG. 1 shows an aircraft fuel tank 10 with liquid fuel 11 to a level 12. In use, the fuel level 12 falls as fuel is used, and rises when fuel is added to the tank 10.

An ullage space 13 above the fuel level 12 is in use inerted with oxygen depleted air (ODA), also known as nitrogen enriched air (NEA). The ODA forms a non-combustible blanket over the fuel.

An air compressor 14 (typically part of an aircraft engine or an auxiliary power unit) supplies air under pressure to an air separation module 15 of known kind, and which produces ODA to the standard required for inerting of the tank 10 by removing oxygen from the air. The supply and control apparatus for delivering ODA to the ullage space 13 is omitted from FIG. 1 for reasons of clarity, but is conventional. Source air may alternatively be supplied from, for example, exhaust cabin air or externally from a ram pipe.

Typically the ODA has an oxygen concentration of 11-12% by volume.

Operating conditions of an aircraft vary considerably due to changes of altitude and temperature, and accordingly to the power demanded from the aircraft engine(s). Conventional systems and methods may be used to determine which of several sources may be used for a particular aircraft operating condition; several sources may be used in combination.

ODA is also supplied under pressure to a manifold 16 via an inlet line 17, and a suitable volume of ODA is provided in a reservoir 18 in order to accommodate fluctuations of supply and demand.

The manifold 16 supplies ODA to four pneumatic devices 22, 26, 24, 33 within the fuel tank 10, and may include pressure and flow regulators of known kind in order that each supply is adapted to the requirements of the respective device. Additionally conditioning apparatus (not shown) may be provided to for example filter and dry the ODA to a required standard. The pneumatic apparatus illustrated in the drawings is by way of example only.

A first supply line 21 supplies ODA under pressure to a pneumatic fuel pump 22 which is immersed in the liquid fuel and has a pick-up pipe 23. Exhaust ODA from the pump 22 enters the ullage space 13 above the fuel, and provides a supply of inerting gas which may reduce the normal requirement supplied in a conventional manner; exhaust ODA from pump 22 may be “bubbled” through the fuel volume, and give an additional benefit of dehydrating the fuel.

Fuel passes from the pump 22 to a pressure regulator 24, and thence to an engine fuel supply duct 25; a pressure switch 26 senses fuel pressure, as will be explained.

A second supply line 27 provides ODA to the pressure switch 26, where it provides a signalling medium via a pneumatic signal line 28 to a pneumatic/electric interface 29. The switch 26 may for example pressurize the pneumatic signal line 28 when fuel pressure is at or above a threshold level, and vent the line 28 when fuel pressure is below the threshold. Venting from the line 28 adds to the inerting gas in the ullage space 13, as described above.

The pneumatic signal line 28 is a means of turning the pump 22 on and off, as will be explained. The switch 26 may alternatively be a proportional device in which the pressure in the pneumatic signal line 28 changes according to pressure in the supply duct 25, and this arrangement may allow for control of a variable speed or variable output pneumatic pump.

Thus the pneumatic signal line 28 conveys fuel pressure information from the pressure switch 26 to the pneumatic/electrical interface 29 by means of a pneumatic signal carried by the ODA in the pneumatic signal line 28. The pneumatic signal may have two levels (ON/OFF), three or more discrete levels (LOW/MEDIUM/HIGH), or it may be continuously variable.

A third gas supply line 31 provides for control of the pressure regulator 24, as will be explained.

A fourth gas supply line 32 provides a signal pressure for a float valve 33, whereby for example signal pressure to the pneumatic/electric interface 29 may be interrupted should the fuel level 12 rise sufficiently to lift the float 34.

It will be appreciated that all of the exemplary pneumatic devices described above and within the fuel tank 10 rely upon pressurized ODA as an operating medium, and that accordingly no electrical equipment is present. The risk of an energy discharge due to an electrical system is accordingly obviated.

The pneumatic/electric interface 29 converts the pneumatic signals from the devices 26, 33 into electrical signals which pass to a fuel computer 35, and are used to control the manifold 16 in addition to supplying information to other aircraft systems 36.

In operation fuel is supplied from the tank to an aircraft engine via the pump 22 and supply duct 25. The ODA in the supply line 21 is used to control the operation of the pump 22. This control may be effected by one of two different methods.

A first method is as follows. The pump 22 runs at a constant speed whenever it is turned on, with the rate of fuel transfer determined by the pressure regulator 24. So in this case the pump 22 provides pressure, not principally flow. As mentioned above, exhaust ODA from the pump 22 enters the ullage space 13 above the fuel without flowing through the pressure regulator 24. The ODA in the supply line 21 is used to energise the pump 22 and act as a pneumatic power source causing the pump 22 to pump the fuel. In other words the ODA in the supply line 21 provides motive power to the pump 22, and this motive power is either turned on or off by pressure and flow regulators in the manifold 16.

A second method is as follows. The pump 22 runs at a variable speed whenever it is turned on, with the rate of fuel transfer determined (at least in part) by the speed of the pump 22. The ODA in the supply line 21 is used to energise the pump 22 and act as a pneumatic power source causing the pump 22 to pump the fuel. As in the first method described above, the ODA in the supply line 21 provides motive power to the pump 22, but in this case the motive power provided by the ODA is continuously variable, or it may vary between discrete levels (for instance low/medium/high) under the control of pressure and flow regulators in the manifold 16. So as the pneumatic power supplied by the ODA in the supply line 21 varies, the speed of the pump 22 varies accordingly.

The fuel computer 35 governs the fuel demand. More than one pump may be provided. Additionally pumps may be provided to circulate fuel between several tanks. Air consumption of an in-tank pneumatic pump may be monitored to give an indication of correct functioning thereof.

The pressure regulator 24 ensures that fuel is supplied at the desired pressure, and is adjusted by a pneumatic signal via a gas supply line 31, under control of the fuel computer 35, for example a pneumatic signal of varying pressure.

By way of example, the pressure regulator 24 may be a butterfly valve with a disk which can be rotated by a quarter-turn between an open position and a closed position. The pneumatic signal on the gas supply line 31 controls a piston (or other actuator) which acts on the disk of the butterfly valve so that the pressure in the gas supply line 31 determines the rotational position of the disk. Thus the pressure of the gas in the supply line 31 is used to adjust a setting of the pressure regulator 24 to adjust the pressure of the flow of fuel in the supply duct 25. The pressure regulator 24 may have only two settings (on/off), it may have three or more discrete settings (low/medium/high) or it may be continuously variable.

The pressure switch 26 gives a pneumatic indication of fuel pressure via pneumatic signal line 28 to the pneumatic/electric interface 29, and thence to the fuel computer 35. As noted above the switch 26 may give an on/off signal for the pump 22, or it may give a proportional signal suitable for feedback control of the pump output using known techniques. An on/off signal may be represented by presence or lack of pneumatic signal in the pneumatic signal line 28.

Optionally if the pressure switch 26 indicates an abnormally low fuel pressure then the fuel computer 35 may direct the aircraft system 36 to provide a warning in the cockpit of the aircraft prompting the pilot to turn off the pump 22.

The float valve 33 provides a simple means of indicating fuel level, for example upon replenishment, to avoid over-filling of the tank. The pneumatic/electric interface 29 may for example provide an electrical signal to a warning system (which is part of the aircraft system 36) should the float valve open.

Other pneumatic devices could be provided for the tank 10, for example multiple pumps and controls as may be required in a practical installation. In accordance with the invention such devices should be pneumatic. The manifold 16 may be adapted to supply ODA to the supply lines 21, 27, 31, 32 at different pressures and rates of flow, and may include a system of prioritizing one or more supply lines in the event of a cessation of source ODA.

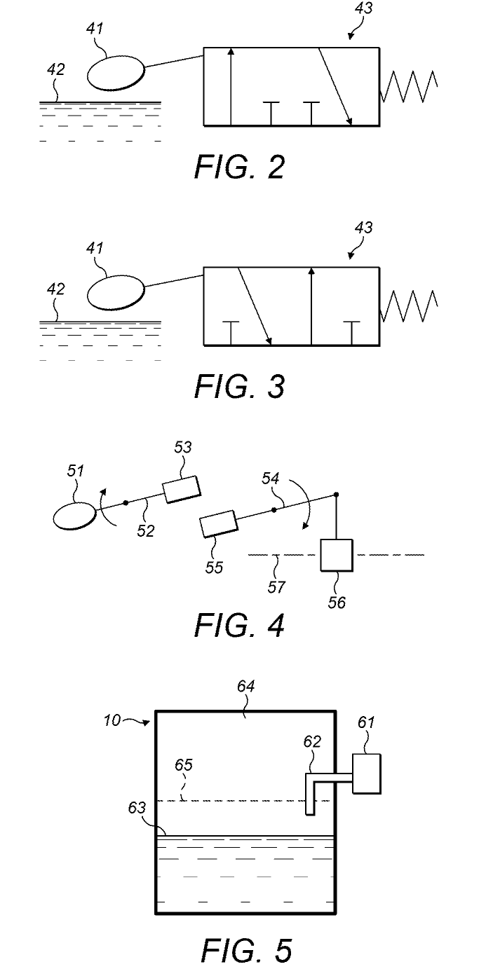

FIGS. 2 and 3 show examples of typical float valves represented by pneumatic circuit diagram symbols.

In FIG. 2, a float 41 lies above the level of fuel 42, and is connected to a normally closed pneumatic valve 43 whereby an air pressure signal is not transmitted to a detector, such as the pneumatic/electric interface 29 of FIG. 1. If the fuel level rises to lift the float, the valve 43 changes state to transmit an air pressure signal to the detector.

FIG. 3 shows an alternative in which the valve 43 is normally open in the down condition of the float, but closes when the float lifts to cease an air pressure signal to the pneumatic/electric interface 29.

FIG. 4 shows another float arrangement whereby a float 51 is mounted upon a lever 52 with a permanent magnet 53. A second lever 54 carries a second permanent magnet 55. The output of the second lever 54 actuates a valve 56 which opens or closes a pneumatic line 57.

In use upward movement of the float results in movement of the second lever by magnetic repulsion, the poles of the magnets 53, 55 being arranged accordingly. The mechanism accordingly has a ‘snap’ action whereby the valve has open and closed states to indicate float level to a detector such as the pneumatic/electric interface 29.

In FIG. 5 a fuel tank 10 has a pneumatic pressure sensor 61 comprising an open downwardly facing tube 62. When the liquid level 63 is below the tube 62, the pressure sensor 61 senses pressure in the ullage space 64. However should liquid level rise and submerge the open end of the tube, as indicated by level 65, air pressure will increase within the tube, and the sensor 61 is adapted to sense this increase and thereby provide a signal to an aircraft system, such as a warning system of high fuel level adapted to close a refuelling valve, or shut-off a refuelling pump. A warning system of low fuel level may provide a reliable indication to the aircraft cockpit.

In the embodiment of FIG. 5, the tube 62 is analogous to the pressure switch 26 and float valve 33, in that it constitutes a device located at least partially inside the fuel tank. The sensor 61 provides a pneumatic/electrical interface outside the fuel tank, and is analogous to the pneumatic/electrical interface 26. The interior of the tube 62 provides a pneumatic signal line between the tube 62 and the sensor 61, and information (in this case an indication of the height of the liquid fuel) is conveyed from the tube 62 to the sensor 61 by means of a pneumatic signal carried by the gas trapped in the tube 62. The sensor 61 is operated to convert the pneumatic signal into an electrical signal indicative of the height of the liquid fuel.

A significant advantage of the invention is that in-tank pneumatic leakage can be tolerated, or promoted in the case of fuel dehydration. Risk of electrical discharge is obviated, and risk of contamination by, for example, a hydraulic motor or other device is also obviated.

The pneumatic fuel pump 22 may be placed in-tank, in contrast to an electrical pump which comprises an electrical motor out-of tank and a mechanical pump in-tank; in the latter case a drive shaft for connecting the motor and pump through the tank wall is required, with the necessity for sealing thereof, and maintenance of such seals.

Modifications and changes to the invention are envisaged within the scope of the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A method of operating a fuel system, the fuel system comprising a fuel tank, a device located at least partially inside the fuel tank, a pneumatic/electrical interface outside the fuel tank, and a pneumatic signal line between the device and the pneumatic/electrical interface, the method comprising:
conveying information from the device to the pneumatic/electrical interface by means of a pneumatic signal carried by a gas in the pneumatic signal line; and
operating the pneumatic/electrical interface to convert the pneumatic signal into an electrical signal.

2. The method according to claim 1 wherein the device is a sensor.

3. The method according to claim 1 wherein the gas is a non-reactive gas.

4. The method according to claim 3, further comprising exhausting the non-reactive gas into the fuel tank.

5. A method of controlling a flow of fuel in a fuel system, the method comprising:
supplying non-reactive gas to a pneumatic device;
operating the pneumatic device to control a flow of fuel in the fuel system; and
using the non-reactive gas to control the operation of the pneumatic device.

6. The method according to claim 5, wherein the fuel system comprises a fuel tank and the method further comprises exhausting the non-reactive gas from the pneumatic device into the fuel tank.

7. The method according to claim 3 wherein the non-reactive gas has either no oxygen, or an oxygen concentration below 15% by volume.

8. The method according to claim 7 wherein the non-reactive gas is oxygen-depleted air with an oxygen concentration below 15% by volume.

9. The method according to claim 8 further comprising generating the oxygen-depleted air by removing oxygen from air at an air separation module.

10. The method according to claim 5 wherein the fuel system comprises a fuel tank, and the pneumatic device is located at least partially inside the fuel tank.

11. The method according to claim 5 wherein the pneumatic device is a pump or pressure regulator.

12. The method according to claim 11 wherein the pneumatic device is a pump which controls the flow of fuel in the fuel system by pumping the fuel, and the gas is used to energise the pump and act as a pneumatic energy source causing the pump to pump the fuel.

13. The method according to claim 11 wherein the pneumatic device is a pressure regulator which controls the flow of fuel in the fuel system by regulating a pressure of the flow of fuel, and the pressure of the gas is used to adjust a setting of the pressure regulator to adjust the pressure of the flow of fuel.

14. The method according to claim 1 wherein the fuel system is an aircraft fuel system.

15. A fuel system comprising:
a fuel tank, a device positioned at least partially inside the fuel tank,
a pneumatic/electrical interface outside the fuel tank, and
a pneumatic signal line between the device and the pneumatic/electrical interface,
wherein the pneumatic signal line is arranged to convey information from the device to the pneumatic/electrical interface by means of a pneumatic signal carried by a gas in the pneumatic signal line, and
the pneumatic/electrical interface is arranged to convert the pneumatic signal into an electrical signal.

16. The fuel system according to claim 15, wherein the gas is a non-reactive gas.

17. The fuel system according to claim 16, further comprising an air separation module for generating the non-reactive gas by removing oxygen from air.

18. The fuel system according to claim 15, wherein the fuel system is an aircraft fuel system.

19. A fuel system comprising:
a pneumatic device; and
a gas supply line for supplying non-reactive gas to the pneumatic device,
wherein the pneumatic device is arranged to control a flow of fuel in the fuel system, and
wherein the gas supply line is arranged to control the pneumatic device by means of the non-reactive gas in the gas supply line.

20. The fuel system according to claim 19, further comprising an air separation module for generating the non-reactive gas by removing oxygen from air.

21. The fuel system according to claim 19, wherein the fuel system is an aircraft fuel system.

22. The method according to claim 5 wherein the fuel system is an aircraft fuel system.
